(19) United States
(12) Patent Application Publication
(10) Pub. No.: US 2017/0321790 A1
(43) Pub. Date: Nov. 9, 2017

(54) FLEX SPLINE ACTUATOR

(71) Applicant: Genesis Robotics LLP, Langley (CA)

(72) Inventors: James Brent KLASSEN, Langley (CA); Stephen Smith Chamberlain, Langley (CA)

(21) Appl. No.: 15/351,337

(22) Filed: Nov. 14, 2016

Related U.S. Application Data
(60) Provisional application No. 62/333,636, filed on May 9, 2016.

(51) Int. Cl. F16H 49/00

(52) U.S. Cl. CPC F16H 49/001; F16H 2049/003

(57) ABSTRACT

A flex spline torque transfer device using force applied at multiple positions for each area of contact between the flex spline and outer ring. The positions of at which force is applied may be outside the areas of contact. This design may also be used in conjunction with a magnetic method of applying force to the flex spline, mechanical force acting as a constraint to prevent the flex spline from fully disengaging from the outer ring.

### FIELD

Harmonic drives, strain wave gears or actuators with flexible splines.

### BACKGROUND

A harmonic drive or flex spline torque transfer device is disclosed in international publication number WO2015168793A2 published Nov. 12, 2015, the disclosure of which is incorporated herein by reference. The present disclosure presents new improvements for harmonic drives in general, and for the harmonic drive of WO2015168793A2 in particular.

### SUMMARY

There is provided a torque transmitting device comprising an outer ring having lobes, and a flexible spline having an inner surface and an outer surface, the flexible spline having lobes on the outer surface of the flexible spline configured to mesh with the lobes on the outer ring, and a force applying element configured to hold the flexible spline in a shape conforming to the outer ring at two or more contact areas, the force applying element configured to exert force on the flexible spline in respect of each contact area at two or more apexes corresponding generally to the respective contact area.

There is also provided a torque transmitting device comprising an outer ring having lobes, and a flexible spline having an inner surface and an outer surface, the flexible spline having lobes on the outer surface of the flexible spline configured to mesh with the lobes on the outer ring, magnets arranged to hold the flexible spline in a shape conforming to the outer ring at two or more contact areas, and a constraining element configured to exert force on the flexible spline at the apexes in the event that the flexible spline partially disengages from the outer ring, to prevent the flexible spline from fully disengaging from the outer ring.

There is further provided a torque transmitting device comprising an outer ring having lobes, and a flexible spline having an inner surface and an outer surface, the flexible spline having lobes on the outer surface of the flexible spline configured to mesh with the lobes on the outer ring, the lobes of the flexible spline having a radially elongated lobe profile with a cross section that is greatest at an intermediate portion of the radial length of the lobes, and a force applying element which holds the flexible spline in a shape conforming in curvature to the outer ring at two or more contact areas.

There is still further provided a torque transmitting device comprising an outer ring having lobes, and a flexible spline having an inner surface and an outer surface, the flexible spline having lobes on the outer surface of the flexible spline, each lobe of the flexible spline having multiple lobe tips configured to mesh with the lobes of the outer ring, and a force applying element which holds the flexible spline in a shape conforming in curvature to the outer ring at two or more contact areas.

There is yet further provided a torque transmitting device comprising an outer ring having lobes, and a flexible spline formed by injection molding and comprising a metallic ring, the flexible spline having an inner surface and an outer surface, the flexible spline having lobes configured to mesh with the lobes of the outer ring, and a force applying element which holds the flexible spline in a shape conforming in curvature to the outer ring at two or more contact areas.

### BRIEF DESCRIPTION OF THE FIGURES

There will be now described embodiments of the various disclosed inventions by reference to the drawings by way of example.

FIG. 1 is a schematic view of a prior art harmonic drive type conventional flex spline gear reducer.

FIG. 2 is a schematic view of a prior art non-toothed flex spline with a conventional mechanical wave generator cam.

FIG. 3 is a schematic view of the four-apex mechanical cam.

FIG. 3A is an enlarged view of one of the cams shown in FIG. 3

FIG. 4 is a schematic of the four-apex roller cam in an ISO view.

FIG. 5 is a schematic of the four-apex roller cam in an exploded ISO view.

FIG. 6 is schematic view of the four-apex roller cam.

FIG. 6A is an enlarged view of one of the cams shown in FIG. 6.

FIG. 7 is a schematic view of an alternate configuration of the four-apex cam. In this configuration, the four geared rollers, 8, are timed and driven primarily through the geared mesh with the sun gear, 5, and can be used with or without the planet carrier, 6, and planet shafts, 7.

FIG. 7A is an enlarged view of one of the cams shown in FIG. 7.

FIG. 8 is an exploded view of the geared roller configuration of the four-apex cam.

FIG. 9 is schematic view of a contacting wave generation and propagation cam, with rolling elements and a four-apex race.

FIG. 9A is an enlarged view of the propagation cam, rolling elements and flex spline of FIG. 9 at a point where the rolling elements are not in contact with the propagation cam.

FIG. 9B is an enlarged view of the propagation cam, rolling elements, flex spline and outer lobe ring of FIG. 9 at the point where the flex spline makes contact with the outer lobe ring.

FIG. 9C is an enlarged view of the rolling elements, flex spline propagation cam, rolling elements, flex spline and outer lobe ring of FIG. 9 at a point where each is in contact with the next.

FIG. 10 shows an exploded ISO view of the rolling element cam.

FIG. 11 is a schematic view of a flex spline construction such as is ideally suited for injection molding.

FIG. 12 is a schematic view of a variation of the orbiting pin coupling that uses spherical ball elements instead of cylindrical pin elements.

FIG. 12A is a cross-sectional view taken about line A-A of FIG. 12.

FIG. 13 is a schematic view of an example of a non-circular ball bearing race as is preferred to achieve smooth torque transfer from the flex spline through the ball elements to a housing member.

FIG. 13A is an enlarged view of one of the spherical ball elements of FIG. 13 in a first position.

FIG. 13B is an enlarged view of one of the spherical ball elements of FIG. 13 in a second position.

FIG. 13C is an enlarged view of one of the spherical ball elements of FIG. 13 in a third position.

FIG. 13D is an enlarged view of one of the spherical ball elements of FIG. 13 in a fourth position.

FIG. 14 is a schematic view of a hybrid cam configuration with a primary wave creation and propagation means and a fail-safe mechanical rolling contact means.

FIG. 15 is an ISO view of a schematic of the hybrid cam configuration of FIG. 14.

FIG. 16 is an ISO view of a lobe geometry construction according to the principles of the present device, having a radially elongated lobe profile with increased lobe width radially inward from the lobe tips.

FIG. 17 is an ISO view of an alternate lobe geometry construction to that shown in FIG. 16, where the effective lobe width at a lobe base is similar to the geometry shown in FIG. 16 for stress reduction on the flex splines, but less material has been removed from the flex splines which increases the magnetic flux capacity of the flex splines.

FIG. 18 is an ISO view of an example of how wider lobe midsections can be combined with narrower lobe bases with a multiple tip per lobe configuration.

FIG. 19 is an ISO view of a second non-limiting example of how wider lobe midsections can be combined with narrower lobe bases with a multiple tip per lobe configuration.

### DETAILED DESCRIPTION

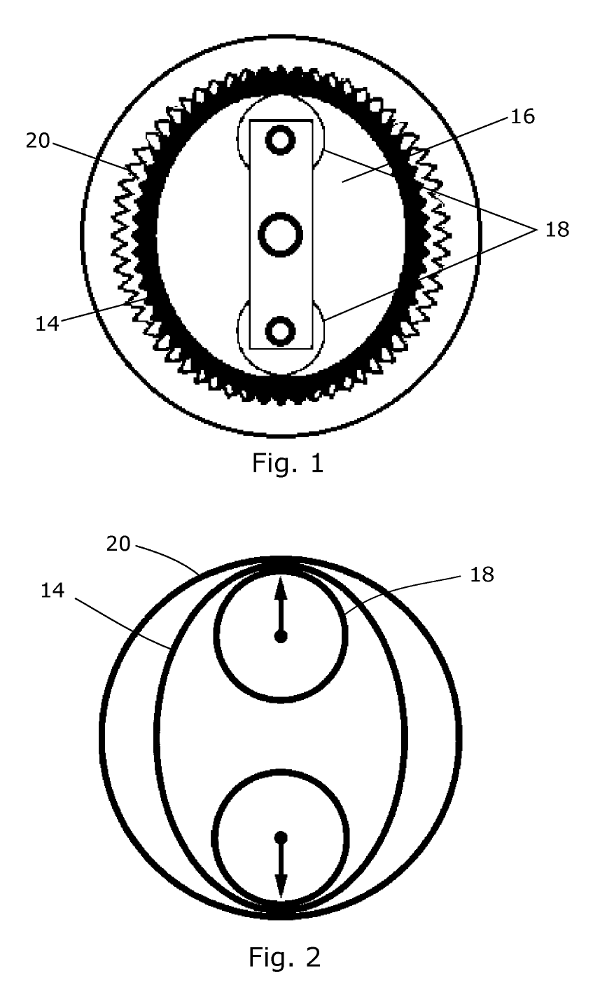

Conventional flex spline gear reducers are generally of the harmonic drive type. As shown in FIG. 1, these devices typically use a mechanical wave form generator 16 which exerts an outwardly radial force on the flex spline 14 to generate an elliptical shape with two apexes. The force is applied directly at the apexes of the flex spline 14 by rollers 18 to press the flex spline against circular ring gear 20. Torque is transmitted from the flex spline to a circular gear ring through teeth on the outside of the flex spline. In order to prevent unwanted interference of harmonic drive flex spline teeth and the ring gear teeth as the flex spline is deformed on either side of the apexes, modified involute tooth forms must be used. These tooth forms can produce a high number of contacting teeth, which can be beneficial for high torque, but the high contact angle of these tooth forms can result in a high separation force between the teeth under load. This high separation force requires high outward radial force of a mechanical wave generating member which is typically a rolling bearing element pushing outwards against the ID of the flex spline. The drawbacks of this mechanical wave generator system include that it occupies significant space in the harmonic drive gearbox, requires very high ball bearing speed to achieve high wave generator input speeds, and must be very high precision to minimize backlash of the tooth engagement. The fixed radial position of the wave generator cam and bearings makes true zero backlash very difficult because manufacturing tolerances and heat expansion can cause closely fitted gears to bind.

Radial outward force from the mechanical wave generator in two or more positions will deform the flex spline into an elliptical shape with the smallest radius of curvature at the ellipse apexes (shown in FIG. 1 at the 12:00 and 6:00 positions). This smaller radius of curvature must be compensated accommodated by the involute shape of the teeth so the flex spline teeth mesh with the circular ring gear teeth without interference. Creating gear teeth with conjugate motion with all of these challenges is extremely difficult, especially with a flexible member which changes shape slightly under load. The result is typically an undesirable amount of noise and vibration, especially as torque increases and the elliptical shape becomes asymmetrical.

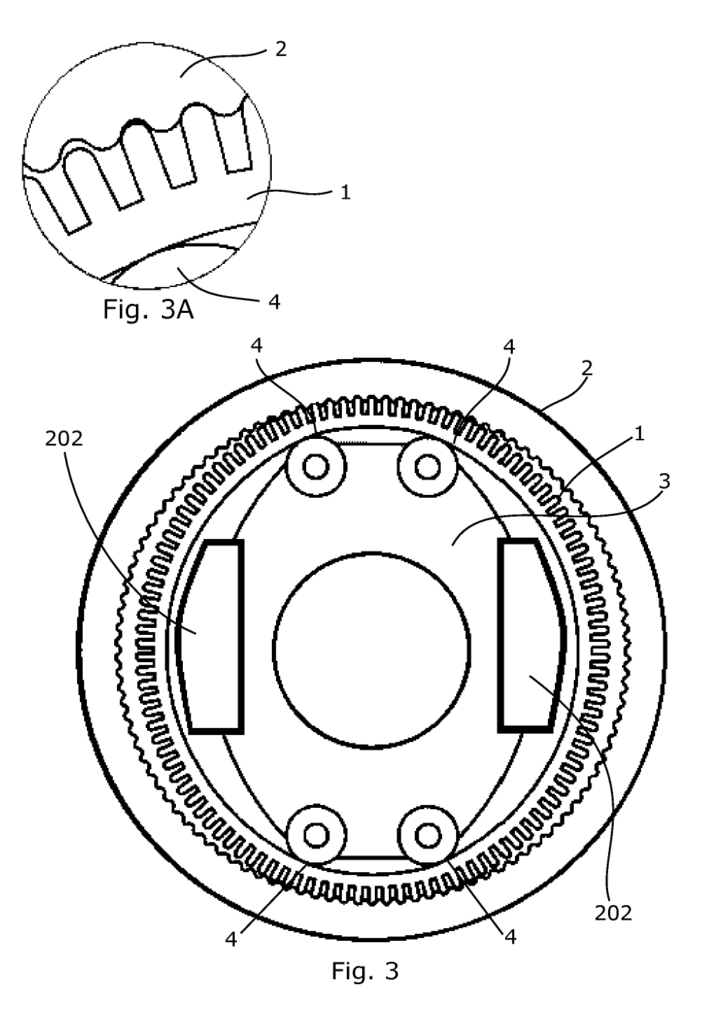

FIG. 2 shows a non-toothed flex spline with a conventional mechanical wave generator cam applying a radially outward force applied to the flex spline at 12:00 and 6:00. The result is a point of contact between the flex spline and the outer ring at each of the two apexes (at the position where the radius of curvature of the flex spline is the smallest anywhere on the flex spline). The involute tooth form of a conventional harmonic drive must compensate for this reduced radius to achieve conjugate motion. In addition, when a torque is transferred through the flex spline, the elliptical shape is deformed asymmetrically, and the tooth form will therefore no longer be conjugate. This is believed to be one of the main reason why harmonic drive gear systems tend to emit gear noise and vibration, especially at higher loads when the flex spline is asymmetrically deformed.

FIG. 3 is a schematic view of the four-apex mechanical cam, and FIG. 3A is an enlarged view of one of the cams shown in FIG. 3. In this document the following abbreviations are used: EM=Electromagnet, FS=Flex spline, ID=Inner diameter, OD=Outer diameter, PM=Permanent magnet, TDC=Top dead center, BDC=Bottom dead center, N=North, S=South, mag ring=magnet ring, ILR=inner lobe ring, OLR=outer lobe ring. FIG. 3 is a schematic of mechanical contact with a four apex cam, and FIG. 3A is an enlarged view of one of the cams shown in FIG. 3.

The four-apex mechanical cam shown here applies a radial force on the FS to prevent disengagement, and, unlike a conventional elliptical roller cam, conforms the FS curvature to the OLR curvature at TDC. An elliptical cam, as is common to the prior art, will exert a maximum outward radial force on the FS at only two apex points directly at TDC. If a conventional two-apex cam is used with the elongated lobes of the present device FS, the lobes would splay directly at TDC instead on either side of TDC as is preferred. Furthermore, a conventional two-apex cam (with a single apex at each of two TDC points) will not cause the FS to conform to the curvature of the OLR.

By configuring the rolling cam with four apexes as shown in FIG. 3, conformity of the FS, 1, to the OLR, 2, at TDC is accomplished. Splaying of the FS lobes is therefore accomplished on either side of TDC and is at its maximum at or near each of the four cam apexes as shown in detail A. Another feature of the four-apex cam, 3, of the present device is a spring loading of the FS radially outward against the OLR at TDC. The four rolling contact apex points, 4, of the cam, 3, are preferably configured at a radial distance which does not fully engage the FS lobe tips with the OLR at each of these four angular positions. Due to the outward curvature of the FS at TDC, the radially outward force at these four points results in a spring preloading of the FS against the OLR at TDC which, in turn, results in the conforming of the FS to the OLR at TDC over an angular distance that is preferably greater than 3 lobes. With radial clearance between the FS lobe tips and the OLR lobes at the four apex points, the roller cam is able to expand due to heat or other factors without causing the FS lobes to bind against the OLR lobes at the four apex points. Likewise, the FS and OLR are able to expand and contract at different rates, within a predefined range, without losing the required preload force of the FS against the OLR at TDC to achieve conformity of the FS with the OLR at TDC for an angular distance of preferably three or more lobes at all times. This ability to account for changes in radial dimensions due to heat expansion and other factors is shown in FIG. 6. FIG. 6A is an enlarged view of one of the cams shown in FIG. 6.

The four apex roller cam disclosed here may use other friction reducing means at each of the four apexes. These friction reducing means may include ball or other roller bearing elements on a four apex race, a four apex gas bearing or a four apex hydrodynamic bearing etc.

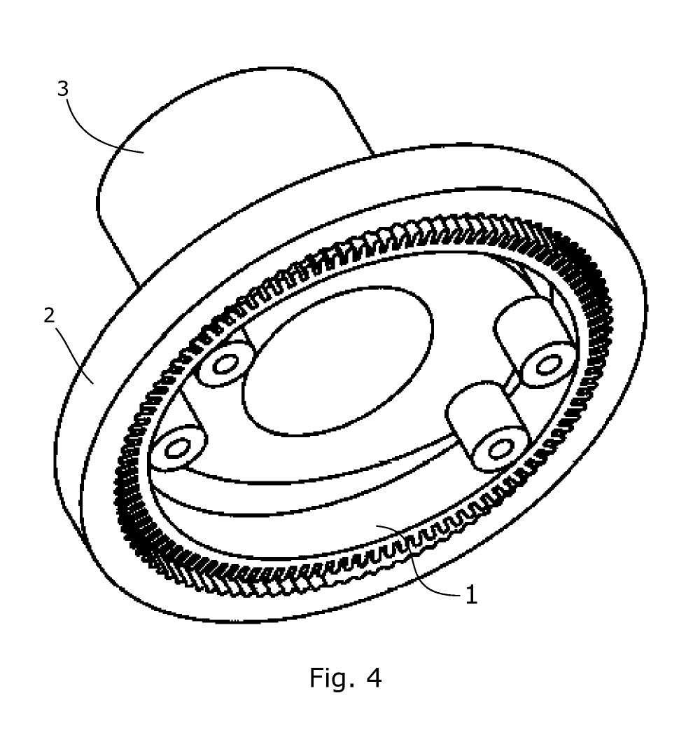

FIG. 4 shows a schematic of the four-apex roller cam in an ISO view.

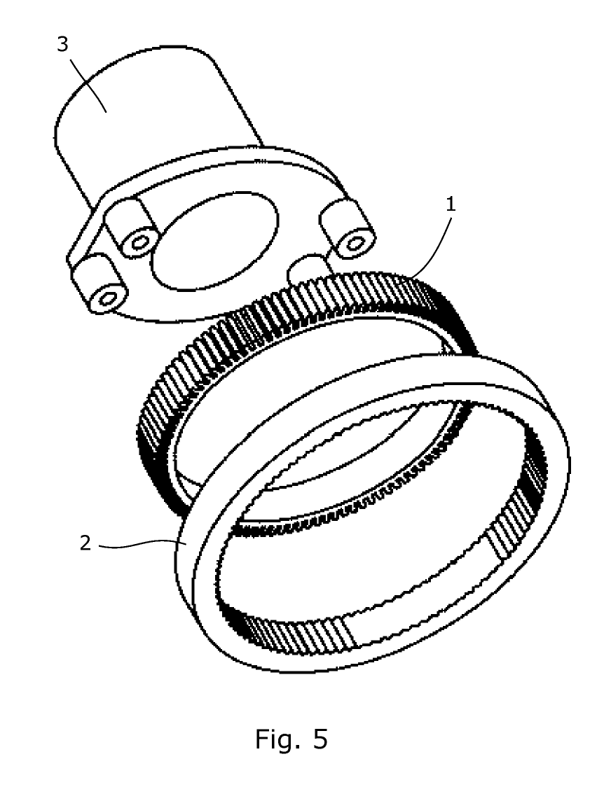

FIG. 5 shows a schematic of the four-apex roller cam in an exploded ISO view.

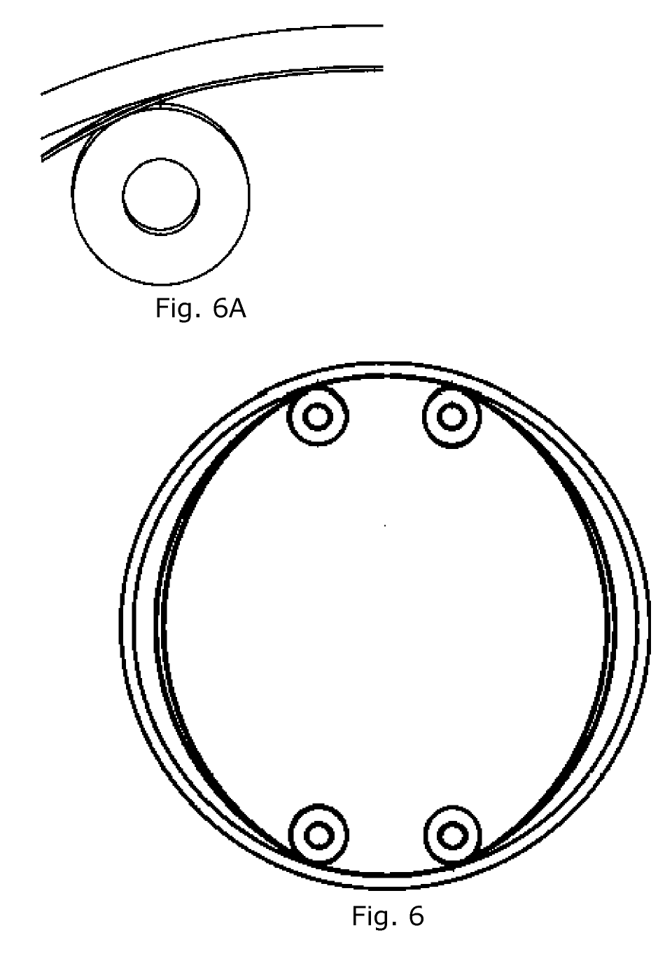

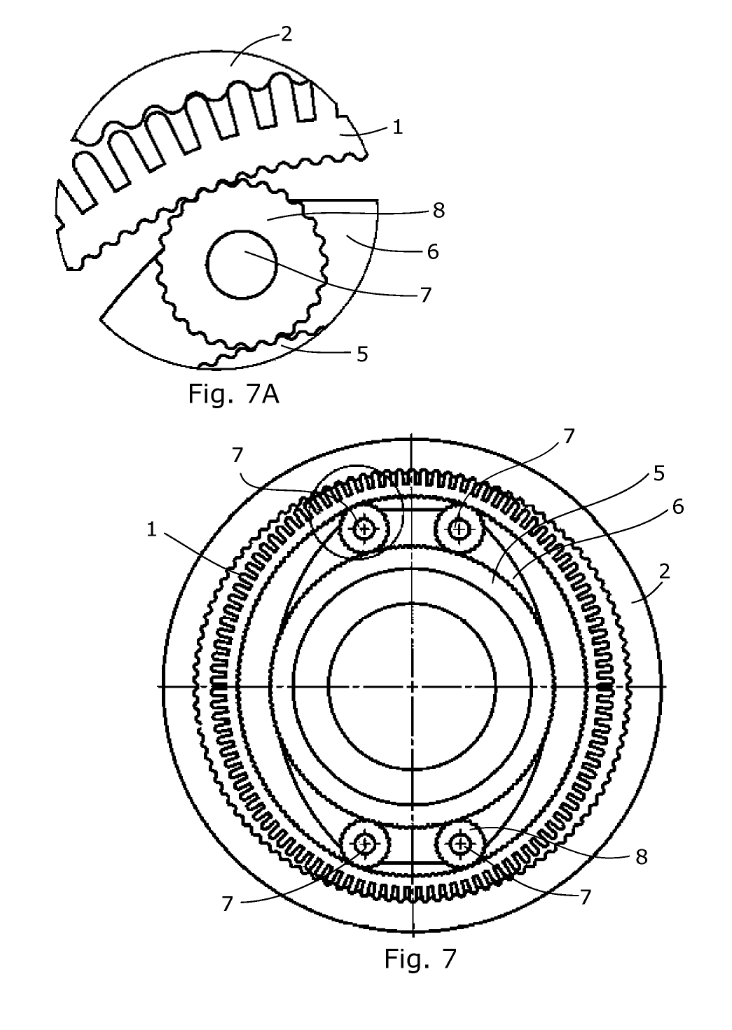

FIG. 7 shows an alternate configuration of the four apex cam. In this configuration, the four geared rollers, 8, are timed and driven primarily through the geared mesh with the sun gear, 5, and can be used with or without the planet carrier, 6, and planet shafts, 7. FIG. 7A is an enlarged view of one of the cams shown in FIG. 7.

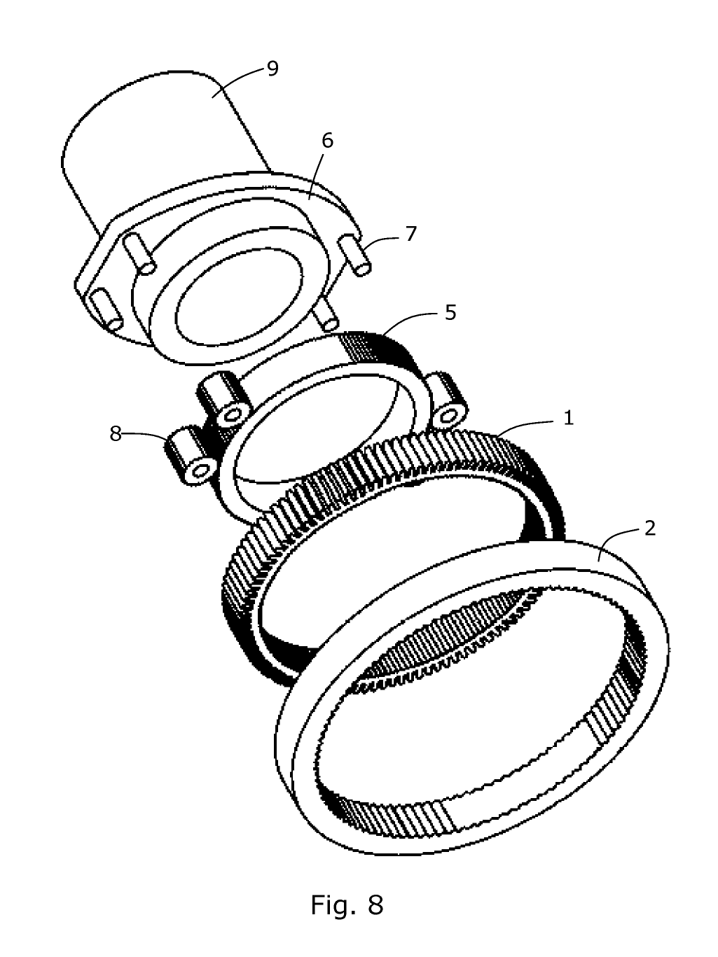

FIG. 8 shows and exploded view of the geared roller configuration. The planet carrier, 6, with planet shafts, 7, may not be necessary if the sun gear, 5, is rotationally fixed to the drive input shaft, 9, or another drive input member such as, but not limited to a motor. Torque output of the present device can also increased with this contacting four-apex cam using geared rollers due to the gear reduction that results from the input to the angular position of the cams because of the sun gear input.

It is understood that the schematic figures of the four-apex contacting cam wave generator and propagation means disclosed here do not show a torque transmission means form the FS to a housing member. This torque transfer can be done in a number of ways such as but not limited to a conventional flexible cylindrical canister or any of the torque transfer devices disclosed here such as the orbiting pin coupling.

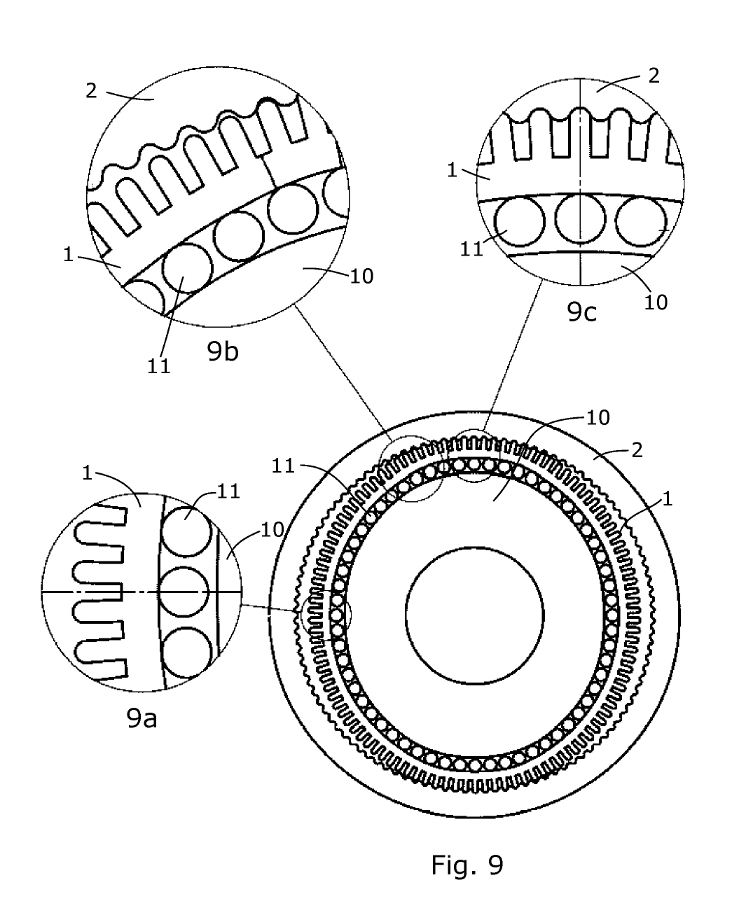

FIG. 9 shows a contacting wave generation and propagation cam, 10, with rolling elements, 11, and a four-apex race. FIG. 9A is an enlarged view of the propagation cam, rolling elements and flex spline of FIG. 9 at a point where the rolling elements are not in contact with the propagation cam.

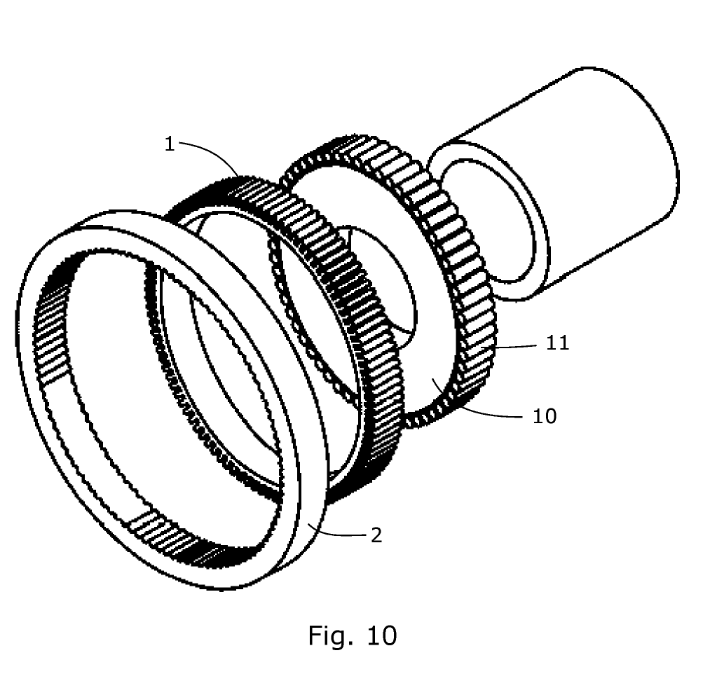

FIG. 10 shows an exploded view of the rolling element cam.

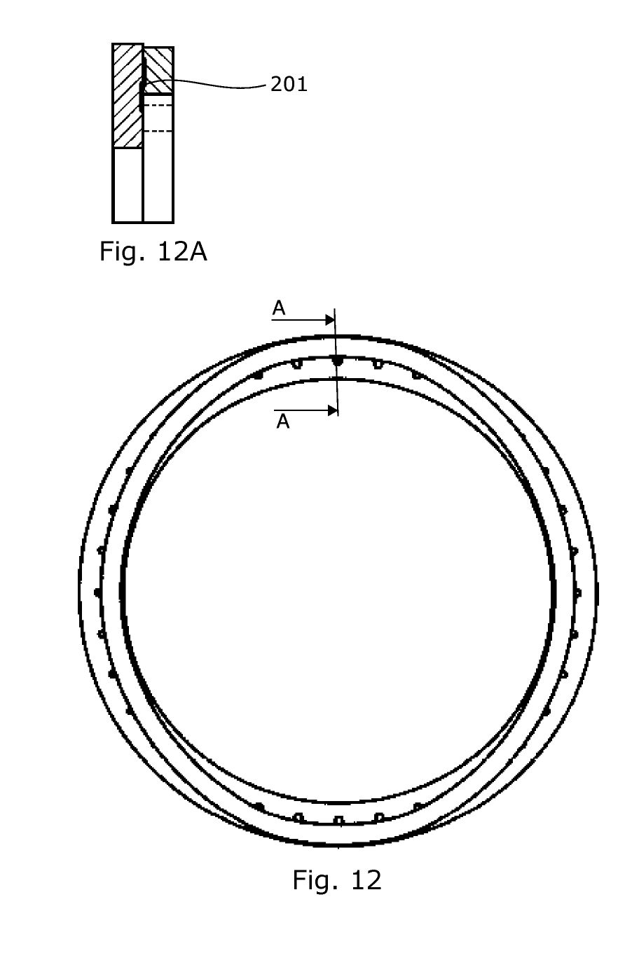

FIG. 12 shows a variation of the orbiting pin coupling that uses spherical ball elements, 201, instead of cylindrical pin elements. The spherical ball elements are located between the axial outward facing ends of the flex spline 14 and the axially inward faces of the housing. The non-circular and somewhat elliptical shape of pockets in the FS and the housing are of axial depth that is preferably slightly less than the diameter of the spherical members. Using ball elements eliminates the need to manufacture the FS with an array of axial through holes in the FS. The housing is sufficiently rigid to allow torque to be transmitted through a portion of the balls from the FS to the housing, as not all the balls will transmit torque at all times. The shape of the pockets allows wave shape to be propagated in the FS while providing contact between non-axial surfaces of the pockets and the balls such that the wave in the FS is free to propagate, but the FS cannot rotate relative to the housing.

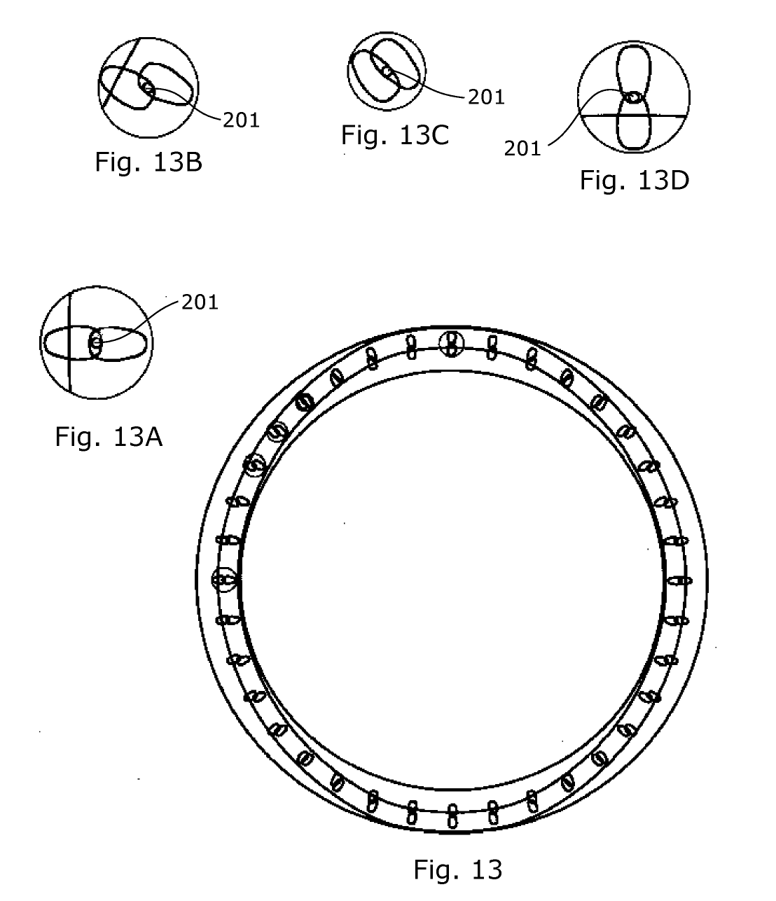

FIG. 13 shows an example of a non-circular ball bearing race as is preferred to achieve smooth torque transfer from the FS through the ball elements, 201, to a housing member.

It is understood that the orbiting ball element coupling is a torque transfer device but it does not create or maintain the wave shape. An additional wave creation and wave propagation device is needed such as are described in this disclosure.

FIG. 13A, FIG. 13B, FIG. 13C and FIG. 13D are enlarged views of one of respective spherical ball elements of FIG. 13.

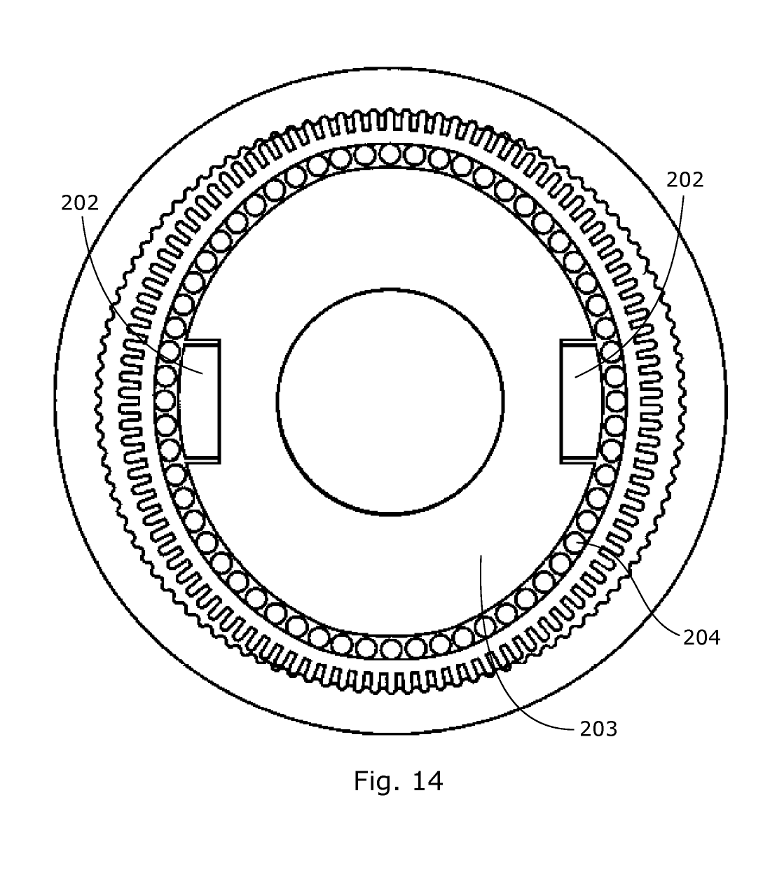

FIG. 14 shows a hybrid cam configuration with a primary wave creation and propagation means and a fail-safe mechanical rolling contact means. Two magnets, 202, or sets of magnets (not shown) are positioned on a rotating cam, 203. These magnets pull in on the FS to create the wave form at 3:00 and 9:00 in this figure, which results in contact of the FS with the OLR at TDC. This magnetic cam effect takes advantage of the low friction and spring preloading of the FS against the OLR. If, at higher torque levels, the separating force of the lobe mesh at TDC causes the FS to partially disengage from the OLR, the rolling element, 204, contact ensures that the FS lobes are not able to completely disengage.

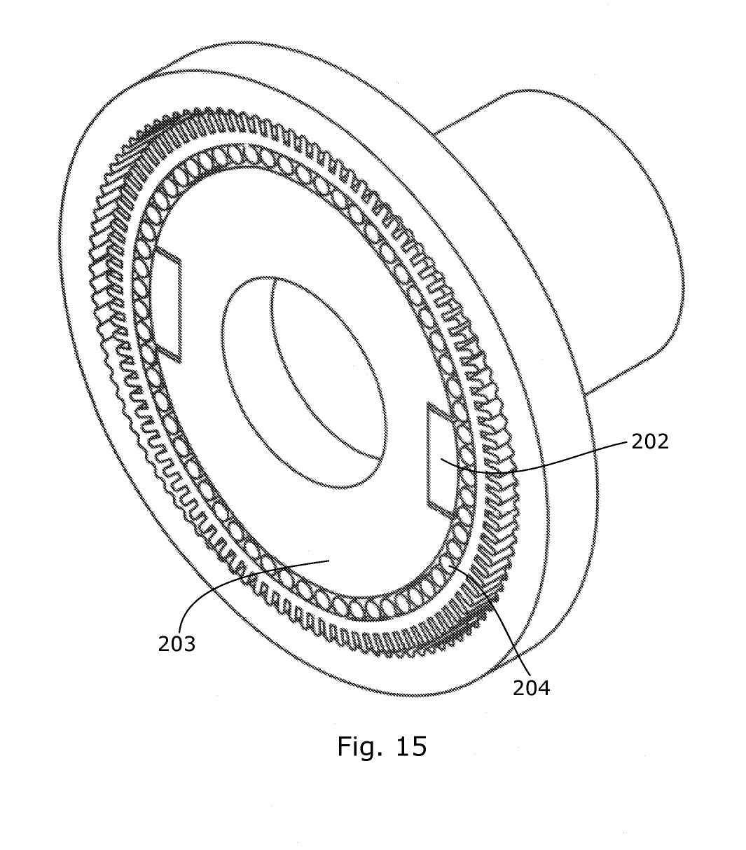

FIG. 15 is an iso view of a schematic of the hybrid cam configuration.

Torque transfer from the FS to a housing member is not shown in this schematic and can be done a number of ways such as is described elsewhere in this disclosure.

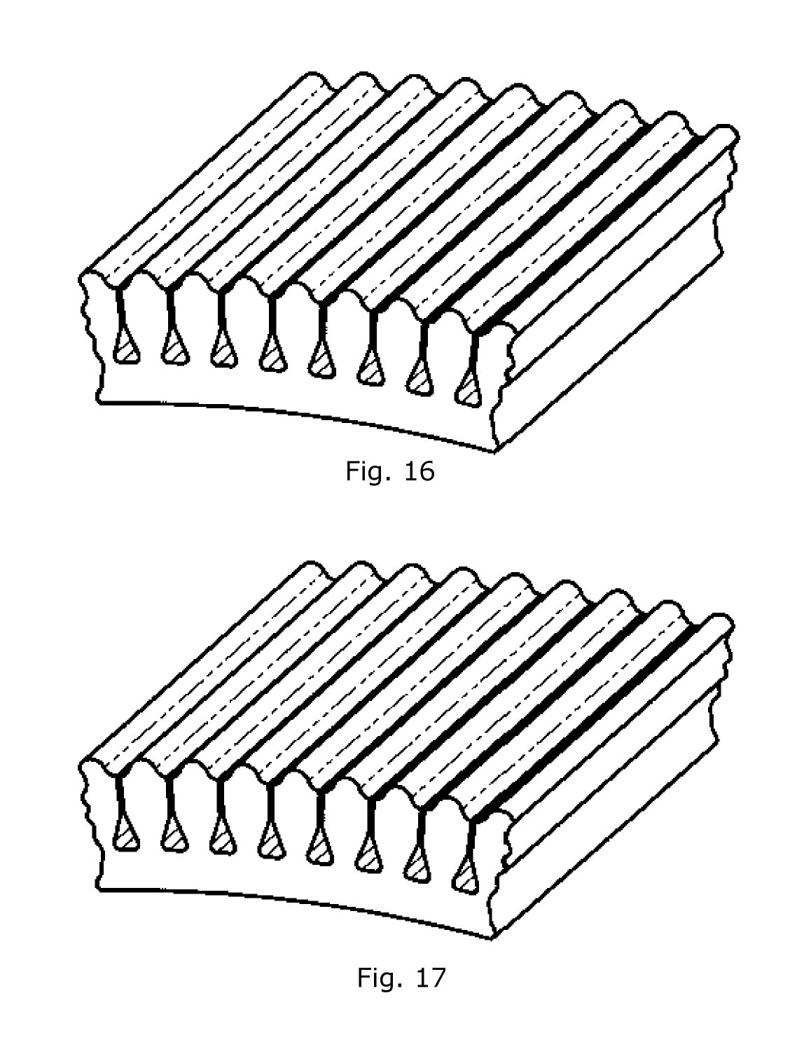

FIG. 16 and FIG. 17 show two different lobe geometry constructions according to the principles of the present device. FIG. 16 shows a radially elongated lobe profile with increased lobe width radially inward from the lobe tips. This construction is beneficial when the FS is being driven with a direct magnetic flux field such as is described elsewhere in this disclosure due to the increase of magnetic material in the lobes on which the magnetic flux can affect. The base of the lobes is narrowed compared to the circumferentially widest sections of the lobes, to reduce the bending stress on the circumferentially uninterrupted section of the FS.

An alternate construction of the FS is shown in FIG. 17. In this example, the effective lobe width at a lobe base is similar to the FIG. 16 geometry for stress reduction on the FS, but less material has been removed from the FS which increases the magnetic flux capacity of the FS. This construction is suitable for manufacturing methods such as but not limited to wire EDM fabrication.

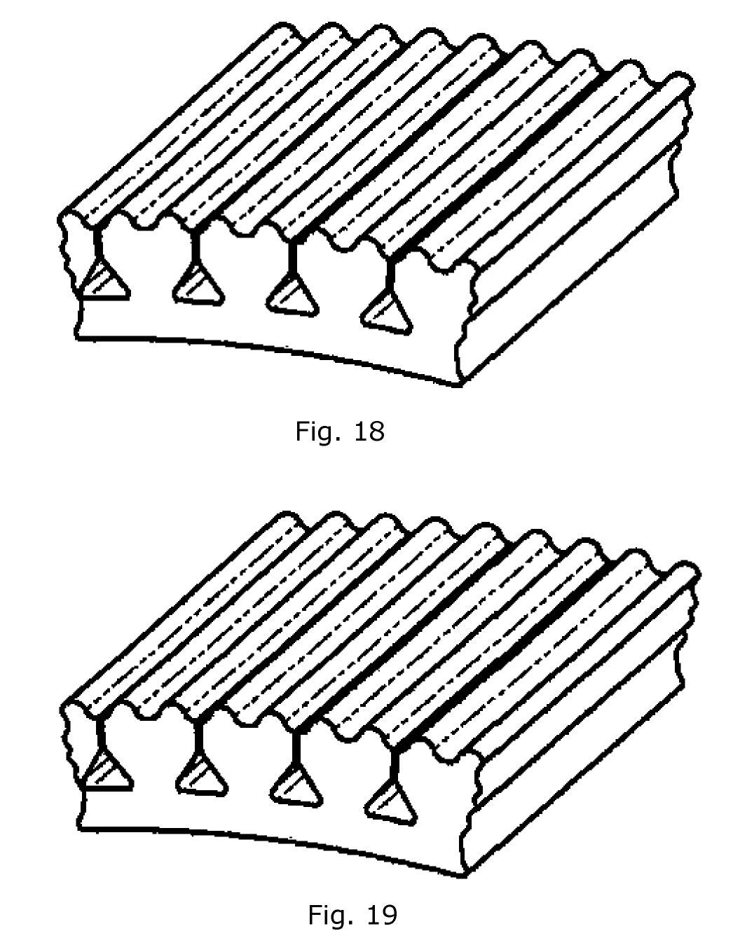

FIG. 18 and FIG. 19 show two non-limiting example of how wider lobe midsections can be combined with narrower lobe bases with a multiple tip per lobe configuration. This geometry can be used to further increase the magnetic material volume of the FS by reducing the total number of radial cuts between the FS lobes.

It is understood that the same principles of construction are applicable to inward facing lobes on the FS.

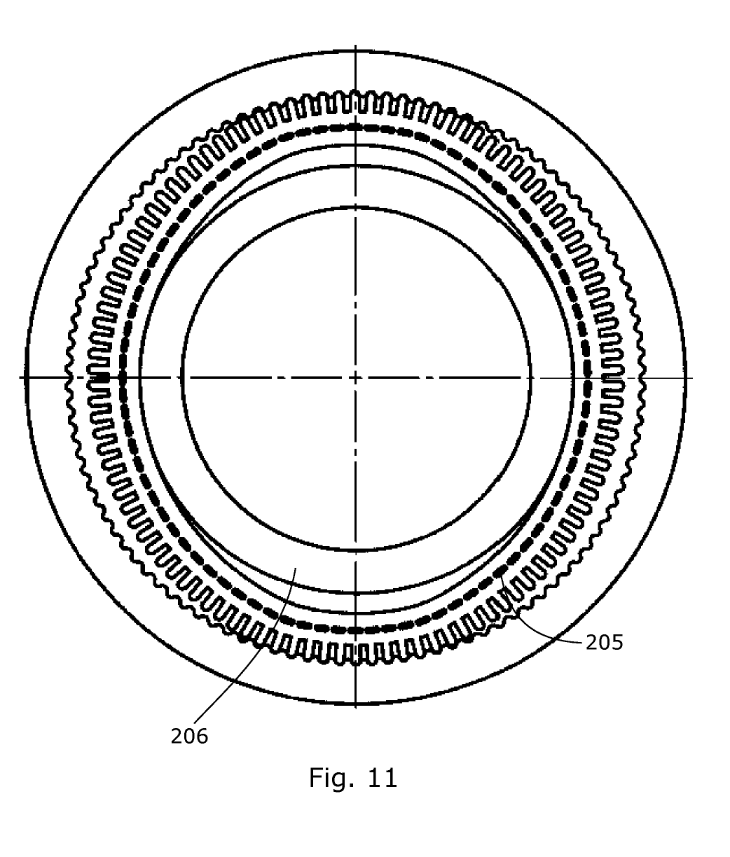

FIG. 11 is a schematic representation of a FS construction such as is ideally suited for injection molding. Plastic materials tend to cold flow more than metal. This makes a plastic FS more prone to bias to a specific wave position if left in that position for an extended period of time. To reduce this effect, a plastic FS can be injection molded with a flexible metallic ring, 205, (illustrated with a dashed line) inserted into the mold before the plastic is injected. A variety of metals can be used. Spring steel is an ideal material due to its high strength and magnetic properties. The magnetic properties of spring steel will allow the use of a non-contacting inner mag ring, 206, as described elsewhere in this disclosure and/or the propagation of the wave with a commutated EM coil array as described elsewhere in this disclosure.

The inserted ring can also be a flexible permanent magnet material, or an array of non-flexible permanent magnets.

This insert construction can be applied to an FS of the present device with external lobes or internal lobes or and FS with both external and internal lobes. Torque transfer from the injection molded FS to a housing member can be done in a number of different ways such as any of the torque transmission coupling methods described in this disclosure.

Immaterial modifications may be made to the embodiments described here without departing from what is covered by the claims. In the claims, the word “comprising” is used in its inclusive sense and does not exclude other elements being present. The indefinite articles “a” and “an” before a claim feature do not exclude more than one of the feature being present. Each one of the individual features described here may be used in one or more embodiments and is not, by virtue only of being described here, to be construed as essential to all embodiments as defined by the claims.

1. A torque transmitting device comprising:
an outer ring having lobes; and
a flexible spline having an inner surface and an outer surface, the flexible spline having lobes on the outer surface of the flexible spline configured to mesh with the lobes on the outer ring; and
a force applying element configured to hold the flexible spline in a shape conforming to the outer ring at two or more contact areas, the force applying element configured to exert force on the flexible spline in respect of each contact area at two or more apexes corresponding generally to the respective contact area.

2. The torque transmitting device of claim 1 in which the apexes correspond to locations on the flexible spline where the flexible spline is not fully engaged with the outer ring.

3. The torque transmitting device of claim 1 in which the apexes are provided by rollers contacting the flexible spline.

4. The torque transmitting device of claim 3 in which the rollers are supported by a planet carrier.

5. The torque transmitting device of claim 3 in which the rollers are supported by a non-circular race.

6. The torque transmitting device of claim 1 in which the apexes are provided by gears configured to mesh with additional lobes on the inner surface of the flexible spline.

7. The torque transmitting device of claim 6 in which the gears are supported by a planet carrier.

8. The torque transmitting device of claim 6 in which the gears are configured to mesh with a sun gear.

9. The torque transmitting device of claim 1 further comprising rolling elements connecting cavities in the flexible spline to corresponding cavities in a non-circular race to transfer torque from the flexible spline.

10. The torque transmitting device of claim 1 in which the flexible spline is attached to a flexible canister to transfer torque from the flexible spline.

11. The torque transmitting device of claim 1 further comprising magnets arranged to hold the flexible spline in the shape conforming to the outer ring at the two or more contact areas, the force applying element being configured to exert force on the flexible spline at the apexes in the event that the flexible spline partially disengages from the outer ring, by constraining the flexible spline to prevent the flexible spline from fully disengaging from the outer ring.

13. The torque transmitting device of claim 1 in which the lobes of the flexible spline have a radially elongated lobe profile with a cross section that is greatest at an intermediate portion of the radial length of the lobes.

14. The torque transmitting device of claim 1 each lobe of the flexible spline has multiple lobe tips, the lobe tips being configured to mesh with the lobes of the outer ring.

15. A torque transmitting device comprising:
an outer ring having lobes; and
a flexible spline having an inner surface and an outer surface, the flexible spline having lobes on the outer surface of the flexible spline configured to mesh with the lobes on the outer ring;
magnets arranged to hold the flexible spline in a shape conforming to the outer ring at two or more contact areas; and
a constraining element configured to exert force on the flexible spline at the apexes in the event that the flexible spline partially disengages from the outer ring, to prevent the flexible spline from fully disengaging from the outer ring.

16. A torque transmitting device comprising:
an outer ring having lobes; and
a flexible spline having an inner surface and an outer surface, the flexible spline having lobes on the outer surface of the flexible spline configured to mesh with the lobes on the outer ring, the lobes of the flexible spline having a radially elongated lobe profile with a cross section that is greatest at an intermediate portion of the radial length of the lobes; and
a force applying element which holds the flexible spline in a shape conforming in curvature to the outer ring at two or more contact areas.

17. The torque transmitting device of claim 16 in which the force applying element comprises magnets situated radially inward from the flex spline and arranged to pull the flexible spline inwardly away from the outer ring at locations between the two or more contact areas.

18. A torque transmitting device comprising:
an outer ring having lobes; and
a flexible spline having an inner surface and an outer surface, the flexible spline having lobes on the outer surface of the flexible spline, each lobe of the flexible spline having multiple lobe tips configured to mesh with the lobes of the outer ring; and
a force applying element which holds the flexible spline in a shape conforming in curvature to the outer ring at two or more contact areas.

19. The torque transmitting device of claim 18 in which the force applying element comprises magnets situated radially inward from the flex spline and arranged to pull the flexible spline inwardly away from the outer ring at locations between the two or more contact areas.

20. A torque transmitting device comprising:
an outer ring having lobes; and
a flexible spline formed by injection molding and comprising a metallic ring, the flexible spline having an inner surface and an outer surface, the flexible spline having lobes configured to mesh with the lobes of the outer ring; and
a force applying element which holds the flexible spline in a shape conforming in curvature to the outer ring at two or more contact areas.
